(19) United States
(12) Patent Application Publication
(10) Pub. No.: US 2009/0109051 A1
(43) Pub. Date: Apr. 30, 2009

(54) Intrusion deterrence system and method

(75) Inventors: Jeffrey Bodden, Pine Ridge, FL (US); Steven R. Olsen, Inverness, FL (US)

Correspondence Address: JEFFREY BODDEN, 4029 W ALAMO DRIVE, PINE RIDGE, FL, 34465, US

(73) Assignee: Jeffrey Bodden

(21) Appl. No.: 11/978,308

(22) Filed: Oct. 29, 2007

(51) Int. Cl. G08B 7/00; G08B 13/00; G08B 5/36

(52) U.S. Cl. 340/691.2; 340/541; 340/815.45

(57) ABSTRACT

The invention relates generally to physical security, and more particularly, but without limitation to systems and methods that simulate television operation, and thus occupancy, for the purpose of deterring intrusion into a building. Embodiments of the invention control a multi-color lighting device, such as a Light Emitting Diode (LED) array, in a way that simulates light that is output from an operational TV screen. In embodiments of the invention, the multi-color lighting device may also simulate light that is output from a table lamp or other white light source. An audio device may also be used in combination with, or in the alternative to, the multi-color lighting device.

### BACKGROUND AND SUMMARY

1. Field of the Invention

The invention relates generally to physical security, and more particularly, but without limitation to systems and methods that simulate television operation, and thus occupancy, for the purpose of deterring intrusion into a building.

2. Description of the Related Art

There exists a need for physical security in personal residences, places of business, and in other buildings.

Conventional building security systems are configured to detect an intrusion and then provide local and/or remote alarms in response to the detected intrusion. Such systems and methods have many disadvantages, however. For instance, local alarms may not be sufficiently audible outside of the building being monitored. In addition, remote alarms, such as those that provide an alert to a monitoring service via telephone communication link, suffer from inherent delays that limit the effectiveness of a law enforcement response. Moreover, local and remote alarms are often falsely triggered, for example by lightning or thunderstorm activity. A high incidence of false alarms for these or other reasons may cause local alarms to be ignored, and may further delay a law enforcement response to the remote alarm.

Intrusion deterrence is an alternative to intrusion detection and response. One method of deterrence is to stage the occupancy of a building. For example, a resident may cause one or more table lamps and/or televisions (TV's) to be in an activated state when the resident is not at home. Power strip timers and other devices are available for this purpose. Such systems and methods are lacking in several respects, however. For instance, table lamps with incandescent bulbs and TV's consume relatively large amounts of electrical power, which may be especially disadvantageous during an extended absence. Furthermore, many modern TV's use a Liquid Crystal Display (LCD) or Plasma Display Panel (PDP) that has a limited usable life before pixel loss, fading, or other permanent and perceptible damage occurs. Accordingly, the use of TV's to stage occupancy may not be economically efficient.

What is needed is a deterrence system and method that does not suffer from the aforementioned shortcomings.

### SUMMARY OF THE INVENTION

Embodiments of the invention seek to overcome one or more of the foregoing limitations by controlling a multi-color lighting device, such as a Light Emitting Diode (LED) array, in a way that simulates light that is output from an operational TV screen. In embodiments of the invention, the multi-color lighting device may also simulate light that is output from a table lamp or other white light source. An audio device may also be used in combination with, or in the alternative to, the multi-color lighting device. Embodiments of the invention are thus configured to consume relatively low power, and avoid the premature mortality risk associated with excessive use of LCD and PDP components.

An embodiment of the invention provides an intrusion deterrence system. The intrusion deterrence system includes: a controller; an audio device coupled to the controller, the audio device configured to operate based on first control signals received from the controller; and a multi-color lighting device coupled to the controller, the multi-color lighting device configured to operate based second control signals received from the controller, the second control signals including scene duration and color mixing information, the intrusion deterrence system thereby configured to simulate an operating television when at least one of the audio device and the multi-color lighting device is in an activated state.

Another embodiment of the invention provides a storage medium. The storage medium includes executable code. The executable code is configured to implement a method. The method includes: selecting a scene duration; selecting a color mixing definition; and outputting control signals to a multi-colored LED device based on the selected scene duration and the selected color mixing definition, the color mixing definition including a plurality of light intensity values, each of the plurality of light intensity values associated with a corresponding one of a plurality of colors associated with the multi-colored LED device.

### BRIEF DESCRIPTION OF THE DRAWINGS

The present invention will be more fully understood from the detailed description below and the accompanying drawings, wherein:

FIG. 1 is a block diagram of an intrusion deterrence system, according to an embodiment of the invention;

FIG. 2 is a block diagram of an intrusion deterrence system, according to another embodiment of the invention;

FIG. 3 is a flow diagram of a programming process, according to an embodiment of the invention;

FIG. 4 is a flow diagram of a LED control process, according to an embodiment of the invention;

FIG. 5 is an illustration of lighting profiles, according to an embodiment of the invention;

FIG. 6 is a schematic diagram of a multi-color LED array/driver assembly, according to an embodiment of the invention;

FIGS. 7A-7F are plan views of alternative LED arrays, according to embodiments of the invention; and

FIGS. 8A and 8B are perspective views of alternative multi-color lighting devices, according to embodiments of the invention.

### DETAILED DESCRIPTION

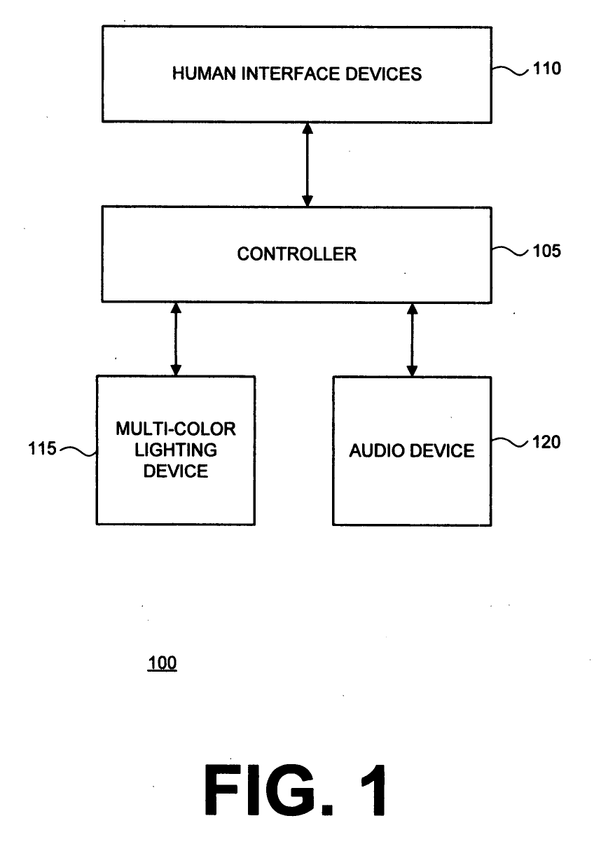

Embodiments of the present invention now will be described more fully with reference to FIGS. 1 through 8B, in which embodiments of the invention are shown. This invention may, however, be embodied in many different forms and should not be construed as limited to the embodiments set forth herein. Rather these embodiments are provided so that this disclosure will be thorough and complete, and will fully convey the scope of the invention to those skilled in the art.

FIG. 1 is a block diagram of an intrusion deterrence system 100, according to an embodiment of the invention. The system 100 includes a controller 105. The system 100 further includes human interfaces 110, multi-color lighting 115, and audio device 120 coupled to the controller 105.

The controller 105 may be or include, for example, a personal computer (PC), a microcomputer, a minicomputer, a Personal Digital Assistant (PDA), a microprocessor, a Digital Multiplexer (DMX) controller (e.g., a controller utilizing the DMX512-A protocol), a Musical Instrument Digital Interface (MIDI) controller, a smart phone, a smart clock, or a security system controller. The controller 105 controls the operation of the multi-color lighting device 115 and the audio device 120.

The human interface devices 110 may be or include, for example, a keyboard, a keypad, a mouse, buttons, switches, one or more alphanumeric displays (such as a 7-segment display), a Liquid Crystal Display (LCD) panel, a Plasma Display Panel (PDP) and/or a Cathode Ray Tube (CRT) monitor. The human interface devices 110 facilitate programming of the controller 105.

The multi-colored lighting device 115 may be or include, for example, Red/Green/Blue (RGB) Light Emitting Diodes (LED's), Red/Yellow/Blue (RYB) LED's, colored neon lamps, colored halogen lamps, white halogen lamps with a color wheel, colored incandescent lamps, or a white incandescent lamps with a color wheel. The multi-color lighting device 115 may further include necessary hardware and/or software drivers for the above-mentioned LED's or lamps. Under the control of the controller 105, the multi-color lighting device 115 emits multi-colored light in a way that simulates light that is output from an operational television (TV) screen. In embodiments of the invention, the multi-color lighting device 115 does not produce recognizable visual images conventionally associated with a TV video channel. Optionally, the controller 105 may cause the multi-color lighting device 115 to produce a white light (or near white light) output to simulate, for example, light that is output from a table lamp or other conventional light source.

The audio device 120 may be or include, for example, a Digital Audio Player (DAP), an internet radio device, a cable radio device, a satellite radio receiver, a terrestrial radio receiver, an analog media player such as a tape deck or video cassette recorder (VCR), a Compact Disc (CD) player, a Digital Video Disc (DVD) player, a Digital Video Recorder (DVR), a Personal Video Recorder (PVR), or an audio synthesizer. The audio device 120 may operate on digital or analog signal sources. In embodiments of the invention, the audio device 120 is configured to simulate an audio channel of TV program content.

In operation, a user may input start times, stop times, and other control parameters to the controller 105 using the human interface devices 110. In embodiments of the invention, a user may input separate control parameters for the multi-color lighting device 115 and the audio device 120. The controller 105 then controls the operation of the multi-color lighting device 115 and/or the audio device 120 based on the user-specified control parameters.

Variations to the block diagram illustrated in FIG. 1 are possible. For instance, in an alternative embodiment, an audio device 120 may not be included. In addition, the operation of the controller 105 may be preset (for example at a manufacturing facility), based on user-selectable flash memory plug-ins, or otherwise programmed such that human interface devices 110 are not needed. Moreover, in alternative embodiments, there may be more than one multi-color lighting device 115 and/or more than one audio device 120. The functional blocks may also be partitioned differently than shown; for example, portions of the control function could be included in the multi-color lighting device 115 and/or the audio device 120, according to design choice.

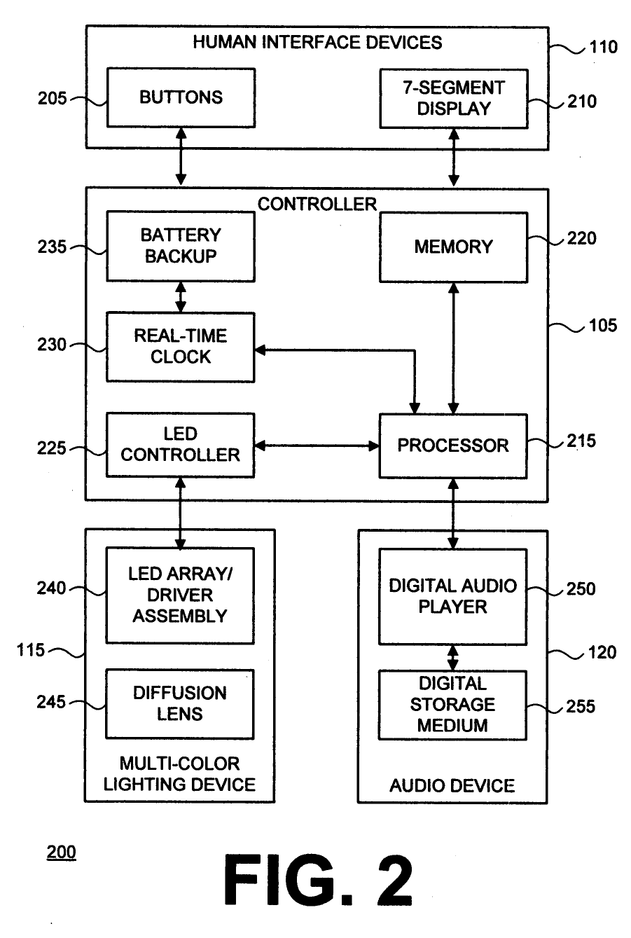

FIG. 2 is a block diagram of an intrusion deterrence system, according to another embodiment of the invention. The system 200 illustrated in FIG. 2 is a variation of the system 100 illustrated in FIG. 1. The system 200 includes a controller 105. The system 200 further includes human interface devices 110, a multi-color lighting device 115, and an audio device 120 coupled to the controller 105.

The controller 105 includes a processor 215. The controller 105 further includes a memory 220, a LED controller 225, and a real-time clock 230 coupled to the processor 215. The controller 105 may further include a battery back-up 235 coupled to the real-time clock 230.

The human interface devices 110 include buttons 205 and one or more 7-segment displays 210.

In the illustrated embodiment, the multi-color lighting device 115 includes a LED array/driver assembly 240 and a diffusion lens 245. The LED array/driver assembly 240 is configured to output multi-colored light, for example using red, green, and blue (RGB) LED's. The diffusion lens 245 distributes light output from the LED array/driver assembly 240 more evenly during operation, for example throughout a room in which the LED array/driver assembly 240 is placed.

In system 200, the audio device 120 includes a Digital Audio Player (DAP) 250 and a digital storage medium 255 coupled to the DAP 250. The DAP 250 may be or include, for example, an MP3 player, a CD player, or a digital jukebox. The digital storage medium 255 may be or include, for example, a flash memory device, a hard drive, a CD, a DVD, or other storage medium.

In operation, an operator can use the human interface devices 110 to program the controller 105 for operation of the multi-color lighting device 115 and/or the audio device 120. In particular, a program may be stored in the memory 220 for execution by the processor 215. The processor 215 may also operate, in part, on date and/or time information provided by the real-time clock 230. The processor 215 may directly control the audio device 120, and the processor may indirectly control the multi-color lighting device 115 via the LED controller 225. The battery back-up 235 provides an alternate power source to the real-time clock 230 in the event, for example, of primary power loss.

Variations to the system 200 illustrated in FIG. 2 are possible. For example, human interface devices 110 could include other input and output devices (described with reference to FIG. 1) in addition to, or instead of, those illustrated in FIG. 2. In addition, in the controller 105, the functions of the LED controller 225 could be performed in the processor 215. Moreover, the use of a battery back-up 235 is optional. Alternatively, the battery back-up 235 could also supply an alternate power source to the memory 220 in the case that memory 220 is or includes volatile memory. With respect to the multi-color LED array/driver assembly 240, the use of the diffusion lens 245 is optional, according to design choice. In addition, other combinations of LED colors could be used instead of red, green, and blue.

In embodiments of the invention, a user may specify light and audio functions together for a full TV simulation mode that activates both the multi-color lighting device 115 and the audio device 120. The full TV simulation mode may be appropriate, for instance, during the early evening. Alternatively, a user may program the controller 105 to activate only the multi-color lighting device 115 (for example during the late evening) or only the audio device 120 (for example during daylight hours).

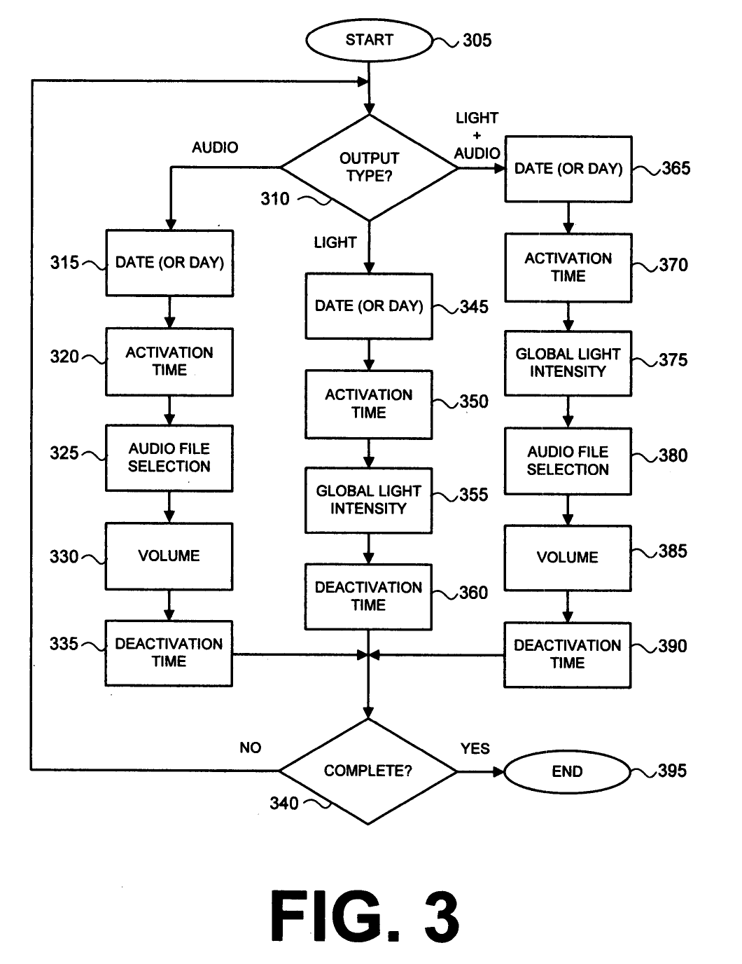

FIG. 3 is a flow diagram of a programming process, according to an embodiment of the invention. The programming process illustrated in FIG. 3 is from the perspective of a program that is executing in the controller 105 while receiving control parameter inputs from a user or other host.

The process begins in step 305 and advances to conditional step 310 where the process determines a type of output device to be programmed. Where the result of conditional step 320 indicates an audio device is to be programmed (by itself), the process advances to step 315 to receive a date selection for the audio function. Then, the process advances to step 320 to receive an activation time. Next, the process advances to step 325 to receive an audio file selection and step 330 to receive a volume selection. Finally, in step 335, the process receives a deactivation time.

The process then is promoted to conditional step 340 to determine whether the programming user or other host is complete. Where the programming is not complete, the process returns to conditional step 310 to determine the type of output device to be programmed. Where the result of conditional step 310 indicates a light program (by itself), the process advances to step 345 to receive a date selection. Then, in step 350, the process receives an activation time. The process then advances to step 355 to receive global light intensity data. Finally, the process advances to step 360 to receive a deactivation time before continuing to conditional step 340.

Where the result of conditional step 310 indicates a combined light and audio program, the process advances to step 365 to receive a date selection, and then to step 370 to receive an activation time. Next, the process advances to step 375 to receive global light intensity data. In step 380, the process receives an audio file selection. Next, in step 385, the process receives a volume selection. The process receives a deactivation time in step 390 before advancing to conditional step 340. Where the result of conditional step 340 indicates that programming is complete, the process terminates in step 395.

User adjustments in audio volume (received in steps 330 and 385) or global light intensity (received in steps 355 and 375) may be appropriate, for instance, based on the size of the room containing the intrusion deterrence system 100, activation times, or other factors. For example, a user may specify a high global light intensity and/or a high audio volume for a large room. Or a user may specify a relatively low audio volume for late night activation hours as compared to daylight activation hours.

Variations to the process illustrated in FIG. 3 are possible. For example, with respect to steps 315, 345, and 365, a day of the week could be received, rather than a particular date. In addition, instead of an audio file selection in steps 325 and 380, the process could receive an audio device selection, channel, CD track, or other information indicative of a particular audio source. Moreover, steps 330 and 385 could be eliminated if volume control is not desired, and/or steps 335 and 375 could be eliminated if global light intensity adjustment is not needed.

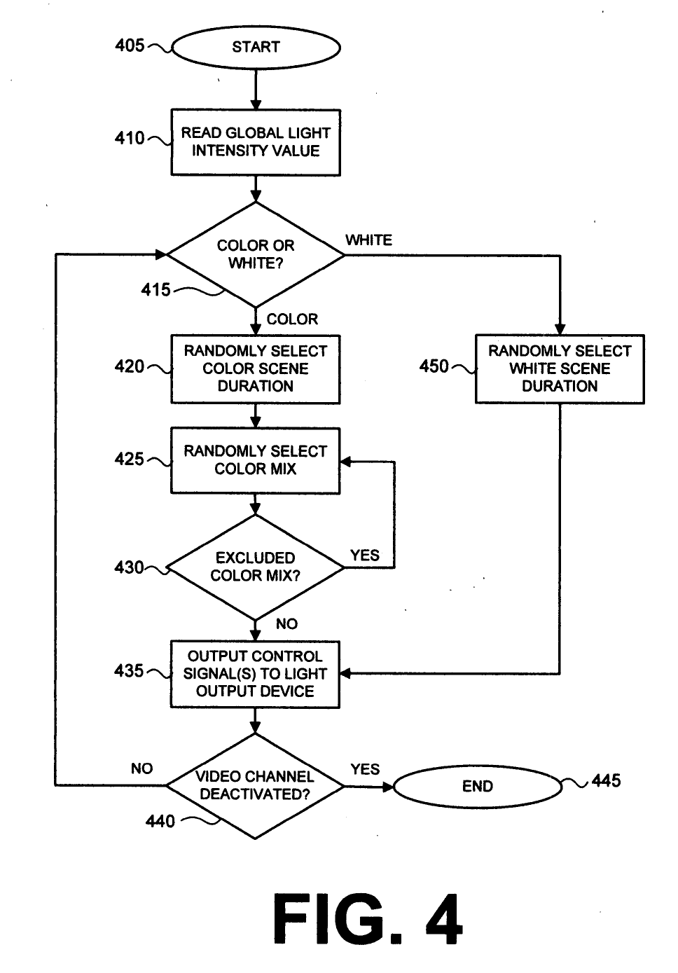

FIG. 4 is a flow diagram of a LED control process, according to an embodiment of the invention. The process begins in step 405 (e.g., when the video channel is activated), then advances to step 410 to read a global light intensity value. Next, the process advances to conditional step 415 to determine whether a program mode is color or white. Where the program mode is for color, the process advances to step 420 to randomly select color scene duration (within predefined limits). Next, the program advances to step to 425 to randomly select a color mix. Then the process advances to conditional step 430 to determine whether the randomly selected color mix is an excluded color mix. Where the result of conditional step 430 is affirmative, the process returns to step 425. Where the result of conditional step 430 indicates that the randomly selected color mix has not been excluded, then the process advances to step 435 to output control signals to a light output device (e.g., the multi-color lighting device 115) for the duration of the scene. Next, in conditional step 440, the process determines whether a video channel has been deactivated. Where the video channel has not been deactivated, the process returns to conditional step 415. Where it has been determined in conditional step 440 that the video channel has been deactivated, the process terminates in step 445. Where it is determined in conditional step 415 that a white light mode has been selected, the process randomly selects a white scene duration (within predefined limits) in step 450 prior to outputting control signals to the multi-color lighting device 115 or other device in step 435. The process illustrated in FIG. 4 thus outputs control signals in step 435 for a continuous stream of color and/or white scenes until the video channel is deactivated.

Color scene durations simulate scenes in TV video content. Accordingly, the random selection of color scene durations may be limited, for example, to a range that extends between 1 and 15 seconds. On the other hand, white scene durations simulate periodic operation of a table lamp or other conventional lighting source. Thus, the random selection of white scene duration may be limited, for instance, to a range that extends between 1 and 15 minutes. Step 415 may operate so that color scenes are selected much more frequently than white scenes.

A color mix may include, for example, an intensity value for each of red, green, and blue colors. In the case of a white light scene, the color mix default may be 100% of red, 100% of green, and 100% of blue color intensity. The purpose of step 430 is to exclude certain color mixes that do not reasonably simulate light that is output from a TV screen based on typical video content. For instance, it may be appropriate to exclude a color mix of 100% red, 0% green, and 0% blue light intensities.

The control signals that are output in step 435 may be associated with the product of global light intensity and each of the color mix values. For example, where the global light intensity is 80%, and the RGB color mix is 20% red, 40% green, and 60% blue intensities, then the control signals output in step 435 may cause a final output of 16% red, 24% green, and 48% blue light intensities for the duration of the scene.

Alternative methods exist for generating control signals that are output to the multi-color LED array/driver assembly 240 in step 435. For instance, a control signal may be configured to vary the amplitude of LED driver voltages. Thus, if the LED array/driver assembly 240 includes 4 blue LED's, the LED controller 225 could send control signals that cause 25% power to be supplied to each of the 4 blue LED's. Alternatively, the LED controller 225 could vary the number of LED's in the LED array/driver assembly that it activates. For instance, the LED controller 225 could send control signals that activate 1 of 4 blue LED's in the LED array/driver assembly 240. Yet another option is that the LED controller 225 can vary the duty cycle of LED's in the LED array/driver assembly. As an example, the LED controller 225 could send control signals to the LED array/driver assembly 240 that produce a 25% duty cycle in each of 4 blue LED's in the LED array/driver assembly 240. Combinations of these methods can also be implemented, according to design choice.

Variations to the process illustrated in FIG. 4 are possible. For example, step 410 can be eliminated if global light intensity is not varied. In addition, in an alternative embodiment, one or more of steps 420, 425, and 450 may be determined by selecting a next value from a table, or these steps may otherwise be performed in non-random fashion. Where step 425 is non-random, step 430 is not required. Moreover, alternative embodiments of the invention do not include white scenes; in this instance, steps 415 and 450 are not required.

In alternative embodiments, output step 435 includes the application of a fading feature to the generated color mix. In one such embodiment, light intensity remains constant overall, but the control signals generated in step 435 are configured to physically reposition light that is output from the multi-color LED array/driver assembly 240. For instance, where light intensity is modulated according to the number of LED's that are activated, fading could include deactivating 2 blue LED's in a first area of the LED array/driver assembly 240 and activating 2 different blue LED's in a second area of the LED array/driver assembly 240 during a selected scene duration. Such deactivation and activation could be implemented as a virtual instantaneous transition, or as a relatively gradual transition. The fading feature may more accurately simulate light that is output from a TV screen that is displaying dynamic video content.

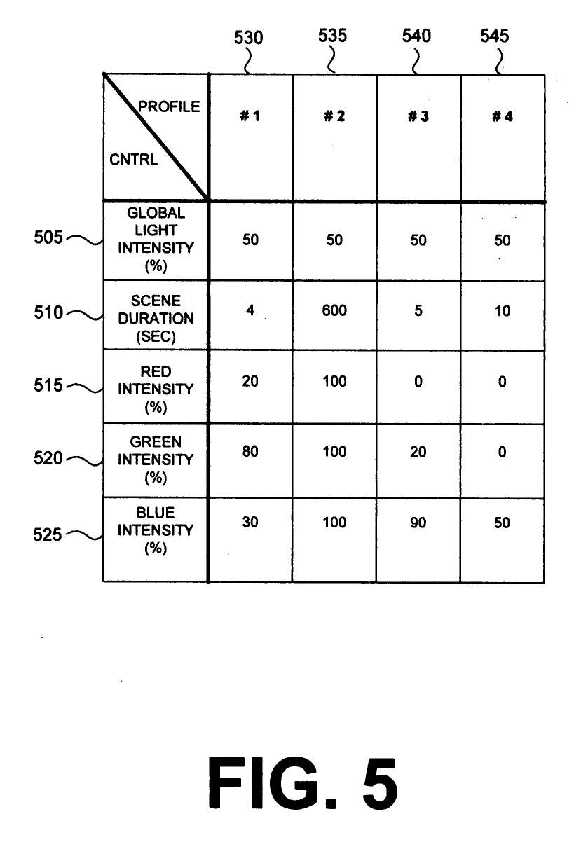

FIG. 5 is an illustration of lighting profiles, according to an embodiment of the invention. Control parameters are illustrated in rows. In particular, row 505 indicates global light intensity, row 510 indicates scene duration, row 515 indicates red light intensity, row 520 indicates green light intensity and row 525 indicates blue light intensity. FIG. 5 also illustrates four representative lighting profiles in each of four columns. More specifically, column 530 illustrates profile #1, column 535 illustrates profile #2, column 540 illustrates profile #3, and column 545 illustrates profile #4.

The global light intensity value shown in row 505 may be the result, for example, of control parameters received by the processor 215 during the programming process illustrated in FIG. 3. The control parameters in rows 510, 515, 520, and 525 are exemplary of control parameters that may be generated by the LED control process illustrated in FIG. 4.

In FIG. 5, profile #'s 1, 3, and 4 represent color scenes and profile #2 represents a white light scene. As described above, the color scenes simulates light output from an operational TV screen, and the white light scene simulates light output from a reading lamp or other white light source. Profile #'s 3 and 4 illustrate that one or more of the multiple colors may have zero intensity in any given color mix.

Lighting profiles may differ from those illustrated in FIG. 5. For instance, alternative embodiments of the invention do not use a global light intensity control parameter, use color combinations other than RGB, and/or do not include a white light profile.

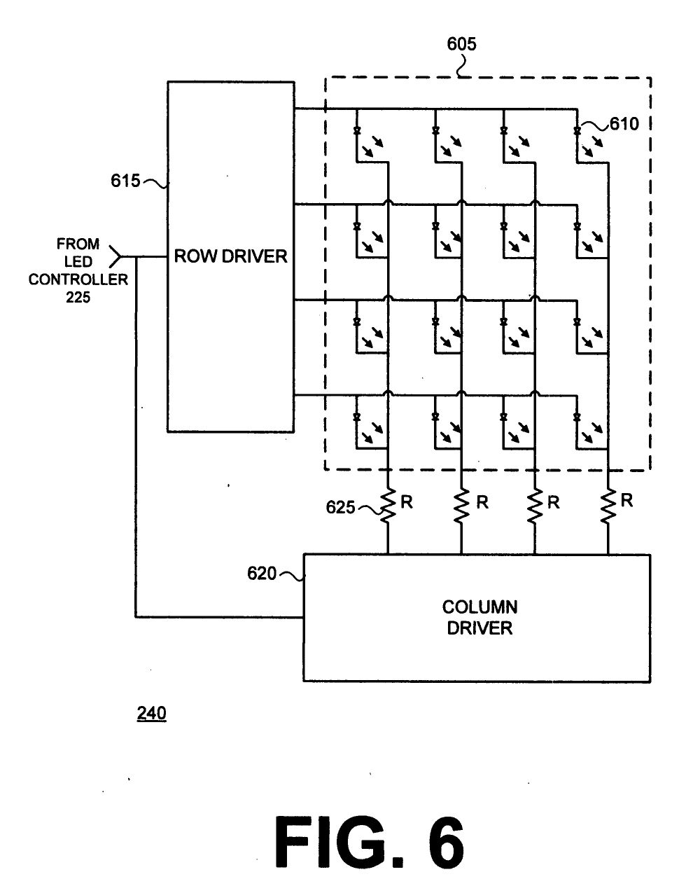

FIG. 6 is a schematic diagram of the multi-color LED array/driver assembly 240, according to an embodiment of the invention. The multi-color LED array/driver assembly 240 includes LED array 605. The multi-color LED array/driver assembly 240 further includes row driver 615 and column driver 620 coupled to the LED array 605. As illustrated, the multi-color LED array/driver assembly 240 also includes multiple resisters 625. Each of the multiple resistors 625 are coupled between a column of the LED array 605 and the column driver 620. In the illustrated embodiment, the LED array 605 includes 16 LED's 610 arranged in a 4×4 matrix.

In operation, the row driver 615 and the column driver 620 receive control signals from the LED controller 225. The row driver 615 sources current to the LED array 605 to a selected row of the LED array 605 and the column driver 620 sinks current from a selected column of the LED array 605. The result of row and column addressing causes one or more LED's 610 to illuminate. The resisters 625 limit current to prevent overdriving the selected LED(s) 610 in the LED array 605.

Alternatives to the schematic diagram illustrated in FIG. 6 are possible. For instance, the LED array 605 could include a different number of LED's 610, according to design choice. In addition, where the data received from the LED controller 225 is in serial format, the row driver 615 and the column driver 625 may include serial to parallel converters. Alternatively, serial to parallel converters could be added separate from the row driver 615 and the column driver 620. Furthermore, although the illustrated schematic may be suitable to vary color intensity by selectively activating one or more LED's in the array 605, additional components may be needed to vary color intensity by adjusting the amplitude of the activation currents or changing the duty cycles.

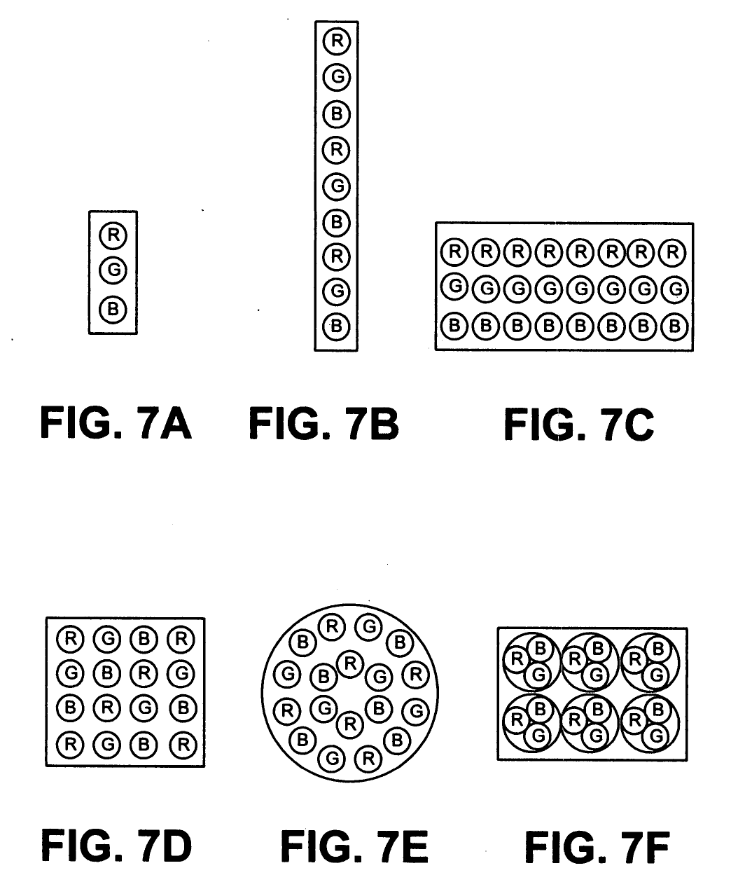

FIGS. 7A-7F are plan views of alternative LED arrays, according to embodiments of the invention. FIG. 7A illustrates three discrete red, green, and blue LED's which may, for example, be arranged in a one-dimensional array. FIG. 7A may be appropriate, for instance, where high-powered LED's are used in the multi-color LED array/driver assembly 240. FIG. 7B illustrates a larger one-dimensional array of red, green, and blue LED's. FIGS. 7C and 7D illustrate two-dimensional arrays of red, green, and blue LED's. In FIG. 7C, the red, blue and green LED's are segregated into different rows according to LED color. In FIG. 7C, the red, green, and blue LED's are more evenly distributed throughout LED array. FIG. 7D is an embodiment of the 4×4 LED array 605 depicted in FIG. 6. FIG. 7E illustrates red, green, and blue LED's arranged within a circular dimension, and FIG. 7F utilizes LED's which are pre-bundled, each bundle having a single red, green, and blue LED.

Other LED array configurations are possible. For example, the multi-color array may use, for example, red, yellow, and blue LED's. Other color combinations may also be used. Moreover, the LED array that forms a part of the LED array/driver assembly 240 may be arranged and shaped according to design choice.

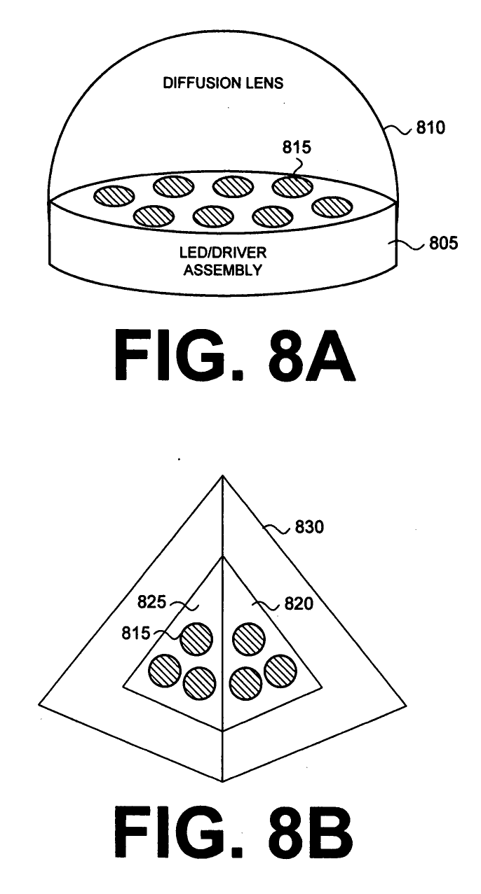

FIGS. 8A and 8B are perspective views of alternative multi-color lighting devices 115, according to embodiments of the invention. FIG. 8A illustrates a LED array/driver assembly 805 having a circular footprint, and having multiple LED's 815 distributed thereon. In addition, the multi-color lighting device 115 illustrated in FIG. 8A includes a hemispherical diffusion lens 810 to diffuse light emitted from the LED's 815 during operation.

FIG. 8B illustrates a LED array/driver assembly 240 having a pyramid shape. The pyramid shape may have, for example, a quadrilateral or trilateral base. The sides of the pyramid may be, for instance, equilateral or isosceles triangles. The LED array/driver assembly 240 illustrated in FIG. 8B includes multiple LED's 815 on at least two sides of the pyramid (e.g., sides 820 and 825). The multi-color lighting device 115 illustrated in FIG. 8B also includes a diffusion lens 830 with a pyramid shape.

A feature of the LED array/driver assembly 240 illustrated in FIG. 8B is that all LED's 815 are not planar. Such feature may direct light emitted from the LED array/driver assembly 240 more widely than alternative planar configurations. In addition, the non-planar approach illustrated in FIG. 8B facilitates simulated motion. For instance, the LED controller 225 may be configured to implement the fading feature (described with reference to FIG. 4) that sequentially activates LED's on side 820 and then on side 825 to simulate right-to-left motion. Other non-planar LED mounting configurations are also possible to achieve this same objective.

The diffusion lenses 810 and 830 may be manufactured, for example, of glass, plastic, or other polymer material. The diffusion lenses 810 and 830 may further be frosted, textured, and/or manufactured with diffusing particles embedded therein.

Embodiments of the invention thus enable a user to deter intrusion into a building by simulating an operational TV, and thus simulating occupancy. Advantageously, embodiments of the invention use LED lighting to limit power consumption during use and avoid the premature mortality risk associated with excessive use of LCD and PDP components that are employed in modern TV's.

It will be apparent to those skilled in the art that modifications and variations can be made without deviating from the spirit or scope of the invention. For example, alternative features described herein could be combined in ways not explicitly illustrated or disclosed. Thus, it is intended that the present invention cover any such modifications and variations of this invention provided they come within the scope of the appended claims and their equivalents.

What is claimed is:

1. An intrusion deterrence system comprising:
a controller;
an audio device coupled to the controller, the audio device configured to operate based on first control signals received from the controller; and
a multi-color lighting device coupled to the controller, the multi-color lighting device configured to operate based second control signals received from the controller, the second control signals including scene duration and color mixing information, the intrusion deterrence system thereby configured to simulate an operating television when at least one of the audio device and the multi-color lighting device is in an activated state.

2. The system of claim 1, further comprising at least one human interface device coupled to the controller.

3. The system of claim 1, wherein the controller includes:
a processor configured to execute a system program;
a memory device coupled to the processor, the memory device configured to store the system program;
a real-time clock coupled to the processor; and
a battery coupled to the real-time clock, the battery configured to supply power to the real-time clock in the event of primary power loss.

4. The system of claim 3, wherein the controller further includes a lighting controller coupled to the processor, the lighting controller configured to generate the second control signals.

5. The system of claim 1 wherein the audio device includes a digital audio player.

6. The system of claim 5, wherein the digital audio player includes at least one of a flash memory device, a hard disk drive, and a compact disc.

7. The system of claim 1, wherein the audio device includes at least one of a cable radio, a satellite radio, a terrestrial radio, and an internet radio.

8. The system of claim 1, wherein the audio device includes an audio synthesizer.

9. The system of claim 1, wherein the multi-color lighting device includes:
a plurality of light emitting diodes; and
a diffusion lens positioned with respect to the plurality of light emitting diodes and configured to diffuse light emitted from the plurality of light emitting diodes.

10. The system of claim 9, wherein the plurality of light emitting diodes are arranged in a planar array.

11. The system of claim 9, wherein the plurality of light emitting diodes are arranged in more than one plane.

12. The system of claim 9, wherein the diffusion lens is hemispherical in shape.

13. The system of claim 9, wherein the multi-color lighting device further includes:
a row driver coupled to the controller and each of the plurality of light emitting diodes, the row driver configured to source a current to a selected row of the plurality of light emitting diodes; and
a column driver coupled to the controller and each of the plurality of light emitting diodes, the column driver configured to sink the current in a selected column of the plurality of light emitting diodes.

14. The system of claim 1, wherein the color mixing information includes a plurality of light intensity levels, each of the plurality of light intensity levels associated with a corresponding one of a plurality of colors associated with the multi-color lighting device.

15. The system of claim 14, wherein the controller is configured to set each of the plurality of light intensity levels at a maximum value during a white light mode.

16. A storage medium, the storage medium including executable code, the executable code configured to implement a method, the method comprising:
selecting a scene duration;
selecting a color mixing definition; and
outputting control signals to a multi-colored LED device based on the selected scene duration and the selected color mixing definition, the color mixing definition including a plurality of light intensity values, each of the plurality of light intensity values associated with a corresponding one of a plurality of colors associated with the multi-colored LED device.

17. The storage medium of claim 16, wherein selecting the scene duration and selecting the color mixing definition are performed randomly.

18. The storage medium of claim 17, wherein the method further includes:
determining whether the color mixing definition is one of a plurality of excluded definitions; and
if the color mixing definition is one of the plurality of excluded definitions, repeating the step of randomly selecting the color mixing definition.

19. The storage medium of claim 16, wherein the method further includes:
selecting one of a color scene and a white scene to produce a scene selection;
if the scene selection is associated with the white scene:
selecting the scene duration is performed randomly from within a first predetermined range; and
selecting the color mixing definition is performed by selecting a maximum light intensity value for each of the plurality of light intensity values; and
if the scene selection is associated with the color scene:
selecting the scene duration is performed randomly from within a second predetermined range; and
selecting the color mixing definition is performed by randomly selecting each of the plurality of light intensity values.

20. The storage medium of claim 16, wherein outputting the control signals includes deactivating a first portion of the LED array and activating a second portion of the LED array within the selected duration and consistent with the color mixing definition.
